(19) United States
(12) Patent Application Publication
(10) Pub. No.: US 2023/0157326 A1
(43) Pub. Date: May 25, 2023

(54) PHASE-STABLE PROTEIN BEVERAGE AND METHODS OF MAKING SAME

(71) Applicant: THE COCA-COLA COMPANY, Atlanta, GA (US)

(72) Inventors: Steve ALLMON, Winter Garden, FL (US); Rachel BUNDANG, Altamonte Springs, FL (US); Winnie OCTAVIA, Orlando, FL (US); Michael RUDAN, Mount Dora, FL (US); Jose GONZALEZ, Brookhaven, FL (US); Joshua MOORE, Apopka, FL (US); Marcelo PEREZ, Apopka, FL (US); Betsy TSE, Visalia, GA (US)

(73) Assignee: THE COCA-COLA COMPANY, Atlanta, GA (US)

(21) Appl. No.: 17/800,731

(22) PCT Filed: Feb. 17, 2021
(86) PCT No.: PCT/US2021/018365

§ 371 Date: Aug. 18, 2022

Related U.S. Application Data
(60) Provisional application No. 62/978,020, filed on Feb. 18, 2020.

(51) Int. Cl. A23L 2/66; A23L 25/00; A23J 1/14

(52) U.S. Cl. CPC A23L 2/66; A23L 25/30; A23J 1/14

(57) ABSTRACT

The disclosed invention includes a description of a phase-stable protein beverage. In addition, method of making a phase-stable protein beverage, that may be substantially or entirely free of rheology modifying and emulsifying chemical ingredients. Additionally, particular embodiments include the production of a substantially, non-dairy, protein beverage with extended shelf life.

This application is being filed on Feb. 17, 2021, as a PCT International Patent application and claims priority to U.S. Provisional patent application Ser. No. 62/978,020, filed Feb. 18, 2020, the entire disclosure of which is incorporated by reference in its entirety.

### TECHNICAL FIELD

Particular embodiments related generally to phase-stable protein beverages and more specifically to phase-stable protein beverage where the protein component is derived from nuts. Methods of producing such beverages and the products obtainable from the methods are also disclosed in some embodiments.

### INTRODUCTION

Nut milk is a popular beverage, particularly for people who do not wish to consume dairy for either personal or medical reasons. While there are numerous nut milks on the market, most contain extra ingredients (i.e., food additives) that are required to suspend solids and promote oil emulsification. These food additives are used in the market place to prevent the product from separating over the shelf-life of the product. For example, some commercially available nut milks contain food additives such as carrageenan, gellan gum and/or xanthan gum, used as rheology modifiers to thicken and slow/prevent separation. Furthermore, another common class of food additive used to stabilize nut milks are emulsifiers, such as soy or sunflower lecithin. These ingredients facilitate oil in water emulsion formation thereby minimizing or preventing an oil or cream layer from forming over shelf-life. While these food additives have all been deemed safe for food use, there is an increasing consumer demand for foods and beverage with clean labels containing only minimal or simple ingredients.

U.S. Pat. No. 6,153,247 (Stoddard) published 28 Nov. 2000 and U.S. Pat. No. 6,123,976 (Stoddard) published 26 Sep. 2000, both assigned to California Almond Growers Exchange disclose a nut-based beverage, especially an almond based beverage. This beverage is made from a nut butter, to which sodium or potassium citrate is added, then a natural non-hydroxylated soy lecithin emulsifier is added and finally, a natural gum (carrageenan) is added to the formulation.

European patent application EP 2294927 (McCready) by WhiteWave Services Inc., published 16 Mar. 2011 discloses a non-dairy nut-based milk, that starts with a nut butter that is mixed with water, and a dry blend of a hydrocolloid such as a gum. This milk also includes salts, such as sodium chloride and a phosphate salt.

There is a need for the development of phase-stable protein beverages having improved shelf-life in the absence of chemical additives such as rheology modifying gums, emulsifiers and the like

Phase-Stable Protein Beverage and Methods of Making Same

The embodiments of the present disclosure solves the foregoing problems by providing a phase-stable protein beverage in the absence of chemical theology modifiers and emulsifiers.

In one embodiment, the phase-stable protein beverage comprises a protein source, and a water source. A nonexclusive list of protein sources comprises nuts, seeds, grains, legumes, and combinations thereof. In some embodiments, the protein source is in the form of a paste, a butter, or an extract. In a preferred embodiment, the protein source is a nut paste derived from the group consisting of: almonds, cashews, hazelnuts, macadamia nuts, walnuts, coconuts, or combinations thereof. In yet another preferred embodiment the protein source is an almond paste or an almond butter. In some embodiments the nuts are processed by roasting, blanching, or a combination thereof prior to being formed into a paste.

In other related embodiments, the phase-stable protein beverage further comprises: sweeteners (nutritive and non-nutritive), fruit and fruit extracts, and fruit derivatives, vegetables, vegetable extracts and derivatives, flavorings, such as cocoa or vanilla, vitamins, minerals, plant and plant extracts and derivatives, and other plant and animal based nutritive additives (such as DHA, CoQ₁₀, glucosamine, whey protein, amino acids, etc.).

In some embodiments, the phase-stable protein beverage comprises a protein source and a filtered water source. In some embodiments, the water source is a filtered water source, wherein the water source is subjected to methods of purification such as distillation, reverse osmosis (RO), nano-filtration, electrodialysis, or carbon filtration. In some embodiments, the filtered water source is selected from the group consisting of, but not limited to; a water source, an electrodialysis water source, or a distilled water source.

In some embodiments, the water source is selected from the group consisting of, but not limited to: a softened water source, a municipal water source or a filtered water source. In a preferred embodiment, the water source is a filtered water. In yet another preferred embodiment the water source is a RO water source. In still yet another preferred embodiment the water sources is a softened municipal water source.

In another embodiment, the phase-stable protein beverage comprises a protein source, a water source that is treated with at least one buffering agent. In some embodiments, the buffering agent is selected from the group consisting of, but not limited to: acetate, benzoate, bicarbonate, carbonate, citrate, dihydrogen phosphate, hydrogen phosphate, lactate, malonate, phosphate, succinate, tartrate, or combinations thereof, or a salt or a hydrate of a buffering agents.

In some example embodiments, the buffering agent is present in about 10 ppm to about 1000 ppm, in about 100 ppm to about 900 ppm, in about 100 ppm to about 500 ppm, or in about 100 ppm to about 300 ppm. In some embodiments, the buffering agent is present in quantities sufficient to provide a pH between about 6.5 to about 9.0.

In other related embodiments, methods of making the phase-stable protein beverage are provided. In some embodiments, the method of making a phase-stable protein beverage comprises of, blending the protein beverage ingredients in a blend tank with the beverage ingredients including a protein source, a water source, and a buffering agent, to create a blended protein beverage. Once combined the beverage ingredients may further include the step of homogenizing the blended protein beverage to create a first homogenized protein beverage. The homogenized protein beverage can be thermal processed. This product can then be further homogenized, thereby creating a thermally processed protein beverage to create a phase stable protein beverage.

In other embodiments, the method of making a phase-stable protein beverage comprises adding back a buffering agent, removed during RO filtration, to a consistent level to create a buffered water source. Then the buffered water source is combined with a protein source in a blend tank to create a blended protein beverage. The blended protein beverage can be homogenized to create a first homogenized protein beverage, upon thermally processing the first homogenized protein beverage to create a thermally processed protein beverage. Finally, homogenizing the thermally processed protein beverage to create a phase stable protein beverage.

Technical advantages of particular embodiments of the present disclosure include creating a stable, nut-based milk substitute that may be substantially or entirely free of rheology modifiers and emulsifiers. Particular embodiments may provide enhanced quality control while reducing product variation. Further technical advantages of particular embodiments include the production of a protein beverage with extended shelf-life with no phase separation, along with a desirable flavor and mouth feel at a lower cost.

Other technical advantages of the present disclosure will be readily apparent to one skilled in the art from the following figures, descriptions, and claims. Moreover, while specific advantages have been enumerated above, various embodiments may include all, some, or none of the enumerated advantages.

### BRIEF DESCRIPTION OF THE DRAWINGS

For a more complete understanding of the present invention and for further features and advantages thereof, reference is now made to the following description taken in conjunction with the accompanying drawings, in which:

FIG. 1 is a block diagram illustrating a batching system for making a phase-stable beverage that includes nut paste according to a particular embodiment; and

FIG. 2 is an example flow diagram illustrating a method for making nut-based protein beverage according to particular embodiments

FIG. 3 depicts the shelf stability of particular embodiments.

### DETAILED DESCRIPTION

Particular embodiments disclosed herein include creating a phase-stable protein beverage, which may be substantially or entirely free of rheology modifying and emulsifying ingredients. Additionally, particular embodiments include the production of a substantially, non-dairy, phase-stable protein beverage with extended shelf-life. In some embodiments, the protein source is selected from the group consisting of, but not limited to: nuts, seeds, grains, legumes, and combinations thereof. The term “nut” as used herein generally refers to any type of human-edible dry fruit in which the ovary wall becomes very hard (stony or woody) at maturity, and where the seed remains unattached or unfused with the ovary wall. For example, filbert hazelnuts, chestnuts, and pecans may be considered nuts in the botanical sense of the term. In addition, the term “nut” as used herein also generally refers to fruits, and even seeds, that may not be botanically qualified as nuts, but that may have a similar appearance and culinary role. For example, almonds, Brazil nuts, cashews, walnuts, coconut, breadnuts, macadamia nuts, peanuts, pine nuts, and pistachios may be considered nuts in a culinary sense of the term. The example nuts disclosed herein are not intended to be an exhaustive list of all possible nuts that may be used in various embodiments. In a preferred embodiment, the protein source is a nut paste derived from the group consisting of: almonds, cashews, hazelnuts, macadamia nuts, walnuts, coconuts, or combinations thereof. In still yet another preferred embodiment, the protein source is an almond paste or an almond butter. In some embodiments, the nuts are processed by roasting, blanching, or a combination thereof prior to being formed into a nut paste or nut butter.

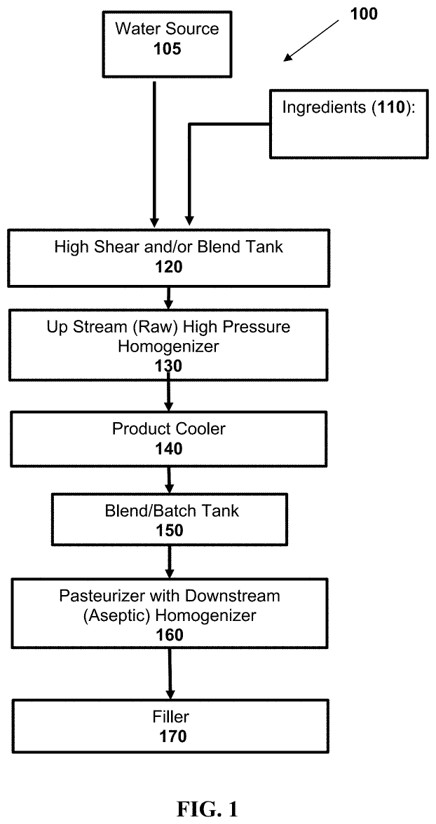

FIG. 1 is one example of a flow diagram 100 illustrating a method for making a beverage that includes nut paste according to a particular embodiment. The method begins by combining water source 105 with ingredients 110 in blend tank 120. Blend tank 120 is capable of receiving ingredients 110 and water source 105. Blend tank 120 is capable of blending ingredients and/or subjecting contents in an agitation cycle. The high-pressure homogenizer 130 illustrated in FIG. 1 is generally capable of pressurizing the product blended by blend tank 120, and homogenization. The product cooler 140 is responsible for cooling the product Upon cooling, the product is transferred to the blend/batch tanker 150 for further blending and then subjected to pasteurization and homogenization in homogenizer 160. Finally, the product is transferred to filler 170 which is generally capable of bottling or packaging the stored product in preparation for distribution. Although method 100 includes a number of elements or modules in this example, other embodiments may include one or more of these or other elements, or may exclude these elements without departing from the scope of the present disclosure.

In some embodiments, the water source 105 is a municipal water source. In some embodiments, the water source is a municipal water source that has been treated with a water softener. In other embodiments, the water source 105 includes a filtered water purified by RO and a buffering agent. In still other embodiments, the water source 105 includes distilled water and a buffering agent.

In some embodiments, the buffering agent is selected from a salt or a hydrate of a food safe or food grade buffering agent. In other embodiments, the buffering agent may include one or more of the following salt or hydrates of: acetate, benzoate. bicarbonate, carbonate, citrate, dihydrogen phosphate, hydrogen phosphate, lactate, malonate, phosphate, succinate, tartrate, or combinations thereof. In some embodiments the buffering agent may include one or more of the following salts or hydrates: ammonium carbonate, ammonium citrate (tribasic), ammonium phosphate (dibasic), ammonium bicarbonate, ammonium hydroxide, calcium carbonate, calcium hydroxide, calcium oxide, calcium lactate, calcium phosphate (monobasic), magnesium carbonate, magnesium hydroxide, magnesium oxide, potassium bicarbonate, potassium citrate, potassium carbonate, potassium phosphate (monobasic), potassium phosphate (dibasic), potassium hydroxide, sodium citrate, sodium bicarbonate, sodium phosphate (dibasic), sodium phosphate (monobasic), sodium carbonate, sodium hydroxide, sodium potassium tartrate, sodium pyrophosphate, sodium sesquicarbonate, or combinations thereof.

In some embodiments, the buffering agent is present in about 10 ppm to about 1000 ppm, in about 100 ppm to about 900 ppm, in about 100 ppm to about 500 ppm, or in about 100 ppm to about 300 ppm. In some embodiments, the buffering agent is present in quantities sufficient to provide a pH between about 6.5 to about 9.0.

In some embodiments, ingredients 110 may include a nut paste may include one or more of the following nuts: almonds, pistachios, hazelnuts, pine nuts, cashews, walnuts, pecans, peanuts, Brazil nuts, Macadamia nuts, breadnuts, chestnuts, coconuts, and/or some other edible nut. For example, combinations of nuts may be used to produce nut paste based on a desirable balance of fat content, taste, consistency, and nutrients provided. In particular embodiments, nuts with a natural skin may be blanched to facilitate removing the skin as part of the nut paste production and/or to protect integrity (e.g., by inactivation of undesirable enzymes). The selected nut or combination of nuts may, for example, be dry or oil roasted and ground to a paste/butter comprising a desired granular size. If multiple nut species are used, each nut species may be separately roasted and ground. In other embodiments, one or more of the multiple nut species can be roasted and ground together. Although this example uses nut paste, other embodiments can use nut butter, nut puree, nut flour, and/or any other ground, liquefied, or extract forms of nuts as a nut paste.

In some embodiments, sweeteners and/or other flavorings may be added to the ingredients 110. In various embodiments, for example, natural evaporated sugar cane or beet juice may be added to ingredients 110. However, other embodiments may be entirely or substantially free of sugar and/or may include one or more sugar substitutes. In some embodiments, salts such as table or sea salt may be added to ingredients 110 as a flavoring agent. In a particular embodiment, for example, one or more stevia extracts may be added in addition to or in lieu of sugar. Certain embodiments may add other types of flavorings to system 100. For example, particular embodiments may include one or more of the following sweeteners and/or flavorings: sugar cane juice, stevia extract, vanilla flavoring, strawberry flavoring, fruit flavoring, chocolate flavoring (e.g., cocoa powder), and/or some other suitable natural or artificial sweetener and/or flavoring. The term “flavoring” as used herein generally refers to any substance that may be safely used in food, the function of which is to impart flavor.

In some embodiments, the ingredients 110 may include the health-related supplements of one or more of the following: calcium carbonate (CaCO₃), vitamin A, vitamin B₂, vitamin B₁₂, vitamin D, vitamin E, zinc, fiber, protein, potassium, phosphorus, fatty acids, (e.g., omega 3, omega 6, etc.), oligosaccharide, and/or any other suitable health-related supplement. In various embodiments, the one or more health-related supplements may be selected based at least in part on a neutral-taste quality that may have little or no impact on the overall taste of the product. In particular embodiments, ingredients 110 may include the addition of the salts of potassium and phosphate ions may provide both a source of both potassium and phosphorus. In some embodiments, fiber may be provided by the addition of dextrin, polydextrose, and/or some other suitable dietary or non-dietary fiber source. In some alternative embodiments, one or more protein-based supplements may optionally be added. In particular embodiments, the one or more protein-based supplements comprise a protein, such as, for example whey protein, yellow pea protein, potato protein, and/or any other suitable protein supplement.

In the first step of 100 the method begins by weighing ingredients 110 and these ingredients with water source 105 in blend tank 120. In blend tank 120 the ingredients 110 are mixed with water source 105. In particular embodiments, ingredients 210, include a nut paste and buffering agent. In other embodiments, ingredients 110 include a nut paste and flavorings.

Once the selected ingredients 110 and water source 105 are added to blend tank 120, the combined mixture or the “product” may be allowed to blend for ten minutes to thirty minutes or any other suitable duration of time. According to one embodiment, the blending in step may include agitation at a constant temperature for an additional five to thirty minutes (e.g., twenty minutes) or any other suitable duration of time and temperature (e.g. 20° C.-50° C.). In particular embodiments, blend tank 120 of method 100 may be capable of performing the optional low-speed agitation.

In this step, a quality check may be performed. For example, a product sample may be pulled from blend tank 120 and analyzed for solids, fat content, proper pi balance, levels of vitamins and nutrients, consistency, etc. The results of this quality check may be used, for example, to make a variety of adjustments for optimization purposes or quality control, including the addition of more buffering agent.

In a high-pressure homogenizer 130, the product is homogenized. In a particular embodiment, homogenization may be accomplished by passing the product under high pressure through a small orifice. For example, the product may be exposed to a maximum homogenization pressure of approximately 500 to 4000 pounds per square inch (psi) (e.g., 3000); however, any suitable maximum pressure may be used. In various embodiments, homogenization may be accomplished using two stages, each with a different pressure (e.g., approximately 2500 psi at a first stage and approximately 500 psi at a second stage). In an alternative embodiment, an ultrahigh homogenization pressure (UNP) may be used. For example, the product may be exposed to a maximum homogenization pressure of approximately 25,000 psi at temperatures over 100° C.

In product cooler 140, the product is cooled to a temperature approximately 0° C. The product may then be transferred to another blend/batch tank 150, followed by downstream pasteurization and homogenization 160 followed by cooling to approximately 4° C. The product is then transferred to the filler system (e.g., filler 170) for bottling or packaging in preparation for distribution. The filler 170 transfers the product into containers. In particular embodiments, the product may be sealed within a single-serve package (e.g., a package containing 3-20 fluid ounces), bag-in-box (e.g., a pouch within a box), pint-sized, half-gallon, full-gallon containers, and/or some other suitable container. Suitable containers include both transparent and opaque containers. Although system 100 includes a number of elements or modules in this example, other embodiments may include one or more of these or other elements, or may exclude these elements without departing from the scope of the present disclosure. For example, some embodiments of system 100 may include ultra-high-temperature processing (UHT) or ultra-high pressure (UHP) pasteurization.

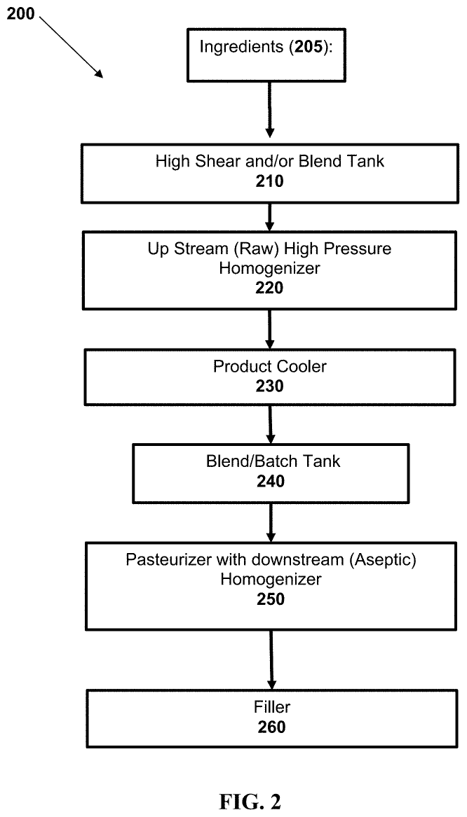

FIG. 2 is one example embodiment of a block diagram illustrating a system 200 for making a phase-stable protein beverage that includes a nut paste. In particular embodiments, the phase-stable beverage produced by system 200 may be substantially or entirely free of rheology modifying and emulsifying ingredients. For example phase-stable beverages produced by system 200 may be substantially or entirely free of pectin, any suitable starches, carrageenan, gellan gum, xanthan gum, locust bean gum (LBG), guar gum, and/or any other hydrocolloid ingredient.

In this example embodiment, system 200 generally includes a high shear blend tank 210, an up-stream high pressure homogenizer 220, a product cooler 230, a blend/batch tank 240, a pasteurizer with downstream homogenizer 250 and a filling module 260.

Blend tank 210 is capable of receiving liquefied ingredients 205 and is capable of blending ingredients and/or subjecting contents to an agitation cycle. In some embodiments ingredients 205 are combined prior to addition to blend tank 210 in other embodiments ingredients 205 are added individually to blend tank 210. The high-pressure homogenizer 220 illustrated in FIG. 2 is generally capable of pressurizing the product blended by blend tank 210, and homogenization. The product cooler 230 is responsible for cooling the product Upon cooling, the product is transferred to the blend/batch tanker 240 for further blending and then subjected to pasteurization with homogenization in homogenizer 250. Finally the product is transferred to filler 260 which is generally capable of bottling or packaging the stored product in preparation for distribution. Although system 200 includes a number of elements or modules in this example, other embodiments may include one or more of these or other elements, or may exclude these elements without departing from the scope of the present disclosure. For example some embodiments of system 200 may include ultra-high-temperature processing (UHT) or ultra-high pressure (UHP) pasteurization.

Ingredients 205 include a water source, nut paste, sweeteners, fruits, and other flavorings. In some embodiments, the water source is a municipal water source. In some related embodiments, the water source is a municipal water source that has been treated with a water softener. In other example embodiments, the water source includes a filtered water. In still other embodiments, the water source includes filtered water purified by distillation, RO, nano-filtration, electrodialysis, or carbon filtration.

Ingredients 205 of some embodiments may also include a buffering agent. In some embodiments, the buffering agent is selected from a salt or a hydrate of a food safe or food grade buffering agent. In example embodiments, the buffering agent may include one or more of the following salt or hydrates of: acetate, benzoate, bicarbonate, carbonate, citrate, dihydrogen phosphate, hydrogen phosphate, lactate, malonate, phosphate, succinate, tartrate, or combinations thereof. In some embodiments the buffering agent may include one or more of the following salts or hydrates: ammonium carbonate, ammonium citrate (tribasic), ammonium phosphate (dibasic), ammonium bicarbonate, ammonium hydroxide, calcium carbonate, calcium hydroxide, calcium oxide, calcium lactate, calcium phosphate (monobasic), magnesium carbonate, magnesium hydroxide, magnesium oxide, potassium bicarbonate, potassium citrate, potassium carbonate, potassium phosphate (monobasic), potassium phosphate (dibasic), potassium hydroxide, sodium citrate, sodium bicarbonate, sodium phosphate (dibasic), sodium phosphate (monobasic), sodium carbonate, sodium hydroxide, sodium potassium tartrate, sodium pyrophosphate, sodium sesquicarbonate, or combinations thereof.

In some embodiments, the buffering agent is present in about 10 ppm to about 1000 ppm, in about 100 ppm to about 900 ppm, in about 100 ppm to about 500 ppm, or in about 100 ppm to about 300 ppm. In some embodiments, the buffering agent is present in quantities sufficient to provide a pH between about 6.5 to about 9.0.

In example embodiments, the nut paste may include one or more of the following nuts: almonds, pistachios, hazelnuts, pine nuts, cashews, walnuts, pecans, peanuts, Brazil nuts, Macadamia nuts, breadnuts, chestnuts, coconuts, and/or some other edible nut. For example, combinations of nuts may be used to produce nut paste based on a desirable balance of fat content, taste, consistency, and nutrients provided.

In particular embodiments, nuts with a natural skin may be blanched to facilitate removing the skin as part of the nut paste production and/or to protect integrity (e.g., by inactivation of undesirable enzymes). The selected nut or combination of nuts may, for example, be dry or oil roasted and ground to a paste/butter comprising a desired granular size. If multiple nut species are used, each nut species may be separately roasted and ground. In other embodiments, one or more of the multiple nut species can be roasted and ground together. Although this example uses nut paste, other embodiments can use nut butter, nut puree, nut flour, and/or any other ground, liquefied or extract form of nut as a nut paste.

In some embodiments, sweeteners and/or other flavorings may be added to the system. In various embodiments, for example, liquid or evaporated sugar cane or sugar beet juice may be added to ingredients 205. However, other embodiments may be entirely or substantially free of sugar and/or may include one or more sugar substitutes. In a particular embodiment, for example, one or more stevia extracts may be added in addition to or in lieu of sugar. In some embodiments, salts such as table or sea salt may be added to ingredients 205 as a flavoring agent. Certain embodiments may add other types of flavorings to system 200. For example, particular embodiments may include one or more of the following sweeteners and/or flavorings: sugar cane or sugar beet juice, stevia extract, vanilla flavoring, strawberry flavoring, fruit flavoring, chocolate flavoring (e.g., cocoa powder), and/or some other suitable natural or artificial sweetener and/or flavoring. The term “flavoring” as used herein generally refers to any substance that may be safely used in food, the function of which is to impart flavor.

In some embodiments, ingredients 205 may include a health-related supplement which may include one or more of the following, calcium carbonate (CaCO₃), vitamin A, vitamin B₂, vitamin B₁₂, vitamin D, vitamin E, zinc, fiber, protein, potassium, phosphorus, fatty acids, (e.g., omega 3, omega 6, etc.), oligosaccharide, and/or any other suitable health-related supplement. In various embodiments, the one or more health-related supplements may be selected based at least in part on a neutral-taste quality that may have little or no impact on the overall taste of the product. In particular embodiments, the addition of the salts of potassium and phosphate ions may provide both a source of both potassium and phosphorus. In some embodiments, fiber may be provided by the addition of dextrin, polydextrose, and/or some other suitable dietary or non-dietary fiber source. In some alternative embodiments, one or more protein-based supplements may optionally be added. In other embodiments, the one or more protein-based supplements comprise a protein. In at least these embodiments a non-exclusive list of proteins include, for example, whey protein, yellow pea protein, potato protein, and/or any other suitable protein supplement, polypeptides or amino acids.

Example formulations that may be used to produce phase-stable protein beverage according to various embodiments are described further in the below examples.

### EXAMPLES

Almond milk prototypes using various water sources and alkalinity levels were prepared according to Table I.

| 1- Control | Reverse Osmosis (RO) water |
|---|---|
| Formulation 2 | Almond Butter + RO + 100 ppm |
| | buffering agent¹ |
| Formulation 3 | Almond Butter + RO + 200 ppm |
| | buffering agent |
| Formulation 4 | Almond Butter + RO + 300 ppm |
| | buffering agent |
| Formulation 5 | Almond Butter + RO + 100 ppm |
| | buffering agent added post-processing² |
| Formulation 6 | Almond Butter + RO + 200 ppm |
| | buffering agent added post-processing |
| Formulation 7 | Almond Butter + RO + 300 ppm |
| | buffering agent added post-processing |
| Formulation 8 | Almond Butter + Softened municipal |
| | water (alkalinity ~120 ppm)³ |

¹All alkalinity levels given as ppm CaCO₃ equivalent.
²Post processing refers to adding the buffer after ultra-high temperature (UHT) processing and downstream food homogenizing.
³No buffering agent was added to this formulation.

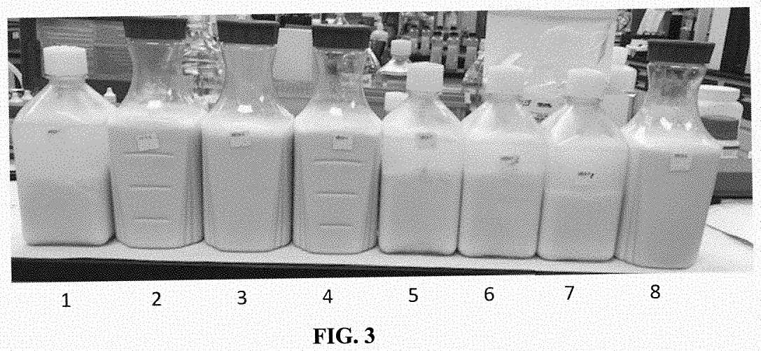

Each formulation was prepared in a batch tank. Each batch tank being rinsed and filled RO water (<20 ρS/m conductivity) at a temperature of 20-30° C. The agitator was then turned on to maintain vigorous mixing without the incorporation of air and the buffering agent was added. The RO water and buffering agent was allowed to mix for 5 minutes. The alkalinity was then measured and adjust if needed to the range of 150-170 ppm. Next, homogenous almond butter (available from Treehouse California Almonds, LLC.) was added to the batch tank and the mixture was agitated for 20 minutes. At this time the remaining dry ingredients and liquid flavors are added to the batch tank followed by mixing for 5 minutes. The “raw batch” is the subjected to upstream homogenization using a pilot scale Rannie homogenizer. The raw batch product was homogenized at 2500 psi first stage and 500 psi second stage into a clean and RO water rinsed hold tank. The temperature, pH and solids of the “raw homogenized” intermediate product were then measured and recorded. If all measurements are within specification, proceed to the next step of UHT heat treatment and downstream homogenization. The raw homogenized product was subjected to temperatures between 140-160° C. for up to 10 seconds at 1.5 liters per minute. The UHT treated product was then homogenized by a pilot scale APV aseptic homogenizer at 80° C., 2500 psi first stage and 500 psi second stage. The downstream homogenized product was then cooled to ˜4° C. and filled into suitable containers, sealed inside a laminar flow cabinet to minimize post UHT contamination. The batch formulations were then transferred to a refrigerator for observation. The formulations were monitored for phase stability over a period of weeks. The phase stability of the experimental formulations are depicted in FIG. 3. AS shown, almond milk prototypes (0.08% salt) using various water sources and/or alkalinity levels. The alkalinity levels described are given as ppm CaCO₃ equivalent, and alkalinity was adjusted only by addition of sodium bicarbonate Example 1 includes RO water Example 2 includes RO water with the addition of 100 ppm alkalinity. Example 3 include RO water with the addition of 200 ppm alkalinity. Example 4 comprises RO water with the addition of 300 ppm alkalinity. Example 5 comprises RO water where 100 ppm alkalinity is added post-processing. Example 6 comprises RO water with the addition of 200 ppm alkalinity added post-processing. Example 7 comprises RO water where the addition of 300 ppm alkalinity is added post-processing. Example 8 comprises softened municipal water (Apopka, Fla.) have an alkalinity of approximately 120 ppm. As can be seen in FIG. 3, Formulations 1, 5, 6 and 7 showed phase separation, while samples 2, 3, 4 and 8 displayed phase stability.

The above specification, examples and data provide a complete description of the manufacture and use of the composition of the invention. Since many embodiments of the invention can be made without departing from the spirit and scope of the invention, the invention resides in the claims hereinafter appended.

1. A phase-stable protein beverage comprising:
a protein source, and
a water source,
wherein the phase stable protein beverage is free of rheology modifying and emulsifying ingredients.

2. The phase-stable protein beverage of claim 1, wherein the protein source is selected from the group consisting of, but not limited to: nuts, seeds, grains, legumes, and combinations thereof.

3. The phase-stable protein beverage of claim 2, wherein the protein source is a nut paste derived from the group consisting of: almonds, cashews, hazelnuts, macadamia nuts, walnuts, coconuts, and combinations thereof.

4. The phase-stable protein beverage of claim 2, wherein the protein source is an almond paste or an almond butter.

5. The phase-stable protein beverage of claim 2, wherein the beverage further comprises: sweeteners, fruit and fruit extracts and derivatives, vegetables and vegetable extracts and derivatives, flavorings, vitamins, minerals, plant and plant extracts and derivatives, and other plant and animal based nutritive additives.

6. The phase-stable protein beverage of claim 1, wherein the water source further comprises a filtered water source wherein the filtration method is selected from the group consisting of, but not limited to: a reverse osmosis, distillation, nano-filtration, electrodialysis, or ultra-filtration.

7. The phase-stable protein beverage of claim 1, wherein the water source is a municipal water source.

8. The phase-stable protein beverage of claim 1, wherein the phase-stable protein beverage further comprises a buffering agent.

9. The phase-stable protein beverage of claim 8, wherein the buffering agent is present in about 10 ppm to about 1000 ppm.

10. The phase-stable protein beverage of claim 9, wherein the buffering agent is selected from the group comprising of: a salt or a hydrate of: acetate, benzoate, bicarbonate, carbonate, citrate, dihydrogen phosphate, hydrogen phosphate, lactate, malonate, phosphate, succinate, tartrate, and combinations thereof.

11. The phase-stable protein beverage of claim 1, wherein the pH of the phase stable protein beverage is between about 6.5 to about 9.0.

12. The method of making a phase-stable protein beverage, the method comprising:
a.) blending the protein beverage ingredients in a blend tank with the beverage ingredients including a protein source, and a water source, to create a blended protein beverage;
c.) homogenizing the blended protein beverage to create a first homogenized protein beverage;
d.) thermally processing the first homogenized protein beverage to create a thermally processed protein beverage; and
e.) homogenizing the thermally processed protein beverage to create a phase stable protein beverage,
wherein the phase stable protein beverage is free of rheology modifying and emulsifying ingredients.

13. The method of claim 12, wherein the protein source is selected from the group consisting of nuts, seeds, grains, legumes and combinations thereof.

14. The method of claim 12, wherein the water source is selected from the group consisting of a reverse osmosis water source, a nano-filtered water source, an electrodialyzed water source, or a municipal water source.

15. The method of claim 12, wherein (a) further comprising adding a buffering agent to the beverage ingredients.

16. The method of claim 15, wherein the buffering agent is present in about 10 ppm to about 1000 ppm.

17. The method of claim 12, wherein the protein source is an almond paste.

18. The method of claim 12, wherein the buffering agent is selected from a group of food grade buffers, comprising a salt or a hydrate of: acetate, benzoate, bicarbonate, carbonate, citrate, dihydrogen phosphate, hydrogen phosphate, lactate, malonate, phosphate, succinate, tartrate, and combinations thereof.

19. The method of claim 15, wherein the protein beverage ingredients further comprises: sweeteners, fruit and fruit extracts and derivatives, flavorings, vitamins, minerals, plant and plant extracts and derivatives, and other plant and animal based nutritive additives.

20. (canceled)
